(19) United States
(12) Patent Application Publication
(10) Pub. No.: US 2020/0387568 A1
(43) Pub. Date: Dec. 10, 2020

(54) METHODS AND SYSTEMS FOR REPORTING REQUESTS FOR DOCUMENTING PHYSICAL OBJECTS VIA LIVE VIDEO AND OBJECT DETECTION

(71) Applicant: FUJI XEROX CO., LTD., Tokyo (JP)

(72) Inventors: Scott CARTER, Foster City, CA (US); Laurent DENOUE, Verona (IT); Daniel AVRAHAMI, Mountain View, CA (US)

(73) Assignee: Fuji Xerox Co., Ltd.

(21) Appl. No.: 16/436,577

(22) Filed: Jun. 10, 2019

(51) Int. Cl. G06F 17/24; H04L 29/08; G06K 9/00; G06K 9/62

(52) U.S. Cl. CPC G06F 17/248; H04L 67/20; G06K 9/00671; G06K 9/6201; G06K 9/00718

(57) ABSTRACT

A computer-implemented method is provided for receiving a request from a third party source or on a template to generate a payload, receiving live video via a viewer, and performing recognition on an object in the live video to determine whether the object is an item in the payload, filtering the object against a threshold indicative of a likelihood of the object matching a determination of the recognition, receiving an input indicative of a selection of the item, and updating the template based on the received input, and providing information associated with the object to complete the request.

### BACKGROUND

### Field

Aspects of the example implementations relate to methods, systems and user experiences associated with responding to requests for information from an application, a remote person or an organization, and more specifically, associating the requests for information with a live object recognition tool, so as to semi-automatically catalog a requested item, and collect evidence that associated with a current state of the requested item.

### Related Art

In the related art, a request for information may be generated by an application, a remote person, or an organization. In response to such a request for information, related art approaches may involve documenting the presence and/or state of physical objects associated with the request. For example, photographs, video or metadata may be provided as evidence to support the request.

In some related art scenarios, real estate listings may be generated by a buyer or a seller, for a realtor. In the real estate listings, the buyer or seller, or the realtor, must provide documentation associated with various features of the real estate. For example, the documentation may include information on the condition of the lot, appliances located in the building on the real estate, condition of fixtures and other materials, etc.

Similarly, related art scenarios may include short-term rentals (e.g., automobile, lodging such as house, etc.). For example, a lessor may need to collect evidence associated with items on the property, such as evidence of the presence as well as the condition of items, before and after a rental. Such information may be useful to assess whether maintenance needs to be performed, items need to be replaced, or insurance claims need to be submitted, or the like.

In the instance of an insurance claim, insurance organizations may require a claimant to provide evidence. For example, in the instance of automobile damage, such as due to a collision or the like, a claimant may be required to provide media such as photographs or other evidence that is filed with the insurance claim.

In another related art situation, sellers of non-real estate property, such as objects sold online, may have a need to document various aspects of the item, for publication in online sales websites or applications. For example, a seller of an automobile may need to document a condition of various parts of the automobile, so that a prospective buyer can view photographs of body, engine, tires, interior, etc.

In yet another related art situation, an entity providing a service (e.g., an entity servicing a printer, such as a multi-function printer (MFP) or the like) may need to document a condition of an object upon which services to be performed, both before and after the providing of the service. For example, an inspector or a field technician may need to document one or more specific issues before filing a work order, or verify that the work order has been successfully completed, and confirm the physical condition of the object, before and after servicing.

In a related art approach in the medical field, there is a need to confirm and inventory surgical equipment. In a surgical procedure, it is crucial to ensure that all surgical instruments have been successfully collected and accounted for after a surgical operation has been performed, to avoid surgical adverse events (SAEs). More specifically, if an item is inadvertently left inside of a patient's body during the course of surgery, and not subsequently remove thereafter, a “retained surgical item” RSI SAE may occur.

In another related art approach in the medical field, a medical professional may need to confirm proper documentation of patient issues. For example, a medical professional will need a patient to provide documentation of a wound, skin disorder, limb flexibility condition, or other medical condition. This need is particularly important when considering patients who are met remotely, such as by way of a telemedicine interface or the like.

For the forgoing related art scenarios and others, there is a related art procedure to provide the documentation. More specifically, in the related art, the documentation required to complete the requests is generated from a static list, and the information is later provided to the requester. Further, if an update needs to be made, the update must be performed manually.

However, this related art approach has various problems and/or disadvantages. For example, but not by way of limitation, the information that is received from the static list may lead to incomplete or inaccurate documentation. Further, as a situation changes over time, the static list may be updated infrequently, if ever, or be updated and verified on a manual basis; if the static list is not updated quickly enough, or if the updating and verifying is not manually performed, the documentation associated with the condition of the physical object may be incorrectly understood or assumed to be accurate, complete and up-to-date, and lead to the above-noted issues associated with reliance on such documentation.

Thus, there is an unmet need in the related art to provide real-time documentation that provides up-to-date and accurate documentation of a condition of a physical object, and avoids problems and disadvantages associated with manual updating and verification of the documentation.

### SUMMARY

According to aspects of the example implementations, a computer-implemented method is provided for receiving a request from a third party source or on a template to generate a payload, receiving live video via a viewer, and performing recognition on an object in the live video to determine whether the object is an item in the payload, filtering the object against a threshold indicative of a likelihood of the object matching a determination of the recognition, receiving an input indicative of a selection of the item, and updating the template based on the received input, and providing information associated with the object to complete the request.

According to further aspects, for the request received from the third party external source, the third party external source comprises one or more of a database, a document, and a manual or automated request associated with an application.

According to additional aspects, wherein, for the request being received via the template, the document is parsed to extract the item; a template analysis application programming interface (API) may generate the payload.

According to still other aspects, the user can select items for one or more sections in a hierarchical arrangement.

According to yet other aspects, the viewer runs a separate thread that analyzes frames of the viewer with the recognizer.

According to further aspects, the object is filtered against items received in the payload associated with the request. Also, each of the items is tokenized and stemmed with respect the object on which the recognition has been performed.

According to additional aspects, the recognizing is dynamically adapted to boost the threshold for the object determined to be in the viewer based on the request.

According to still further aspects, the information comprises at least one of a description, metadata, and media.

Example implementations may also include a non-transitory computer readable medium having a storage and processor, the processor capable of executing instructions for assessing a condition of a physical object with live video in object detection.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates various aspects of data flow according to an example implementation.

FIG. 2 illustrates various aspects of a system architecture according to example implementations.

FIG. 3 illustrates an example user experience according to some example implementations.

FIG. 4 illustrates an example user experience according to some example implementations.

FIG. 5 illustrates an example user experience according to some example implementations.

FIG. 6 illustrates an example user experience according to some example implementations.

FIG. 7 illustrates an example user experience according to some example implementations.

FIG. 8 illustrates an example user experience according to some example implementations.

FIG. 9 illustrates an example process for some example implementations.

FIG. 10 illustrates an example computing environment with an example computer device suitable for use in some example implementations.

FIG. 11 shows an example environment suitable for some example implementations.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting.

Aspects of the example implementations are directed to systems and methods associated with coupling an information request with a live object recognition tool, so as to semi-automatically catalog requested items, and collect evidence that is associated with a current state of the requested items. For example, a user, by way of a viewer (e.g., sensing device), such as a video camera or the like, may sense, or scan, an environment. Further, the scanning of the environment is performed to catalog and capture media associated with one or more objects of interest. According to the present example implementations, an information request is acquired, objects are detected with live video in an online mobile application, and a response is provided to the information request.

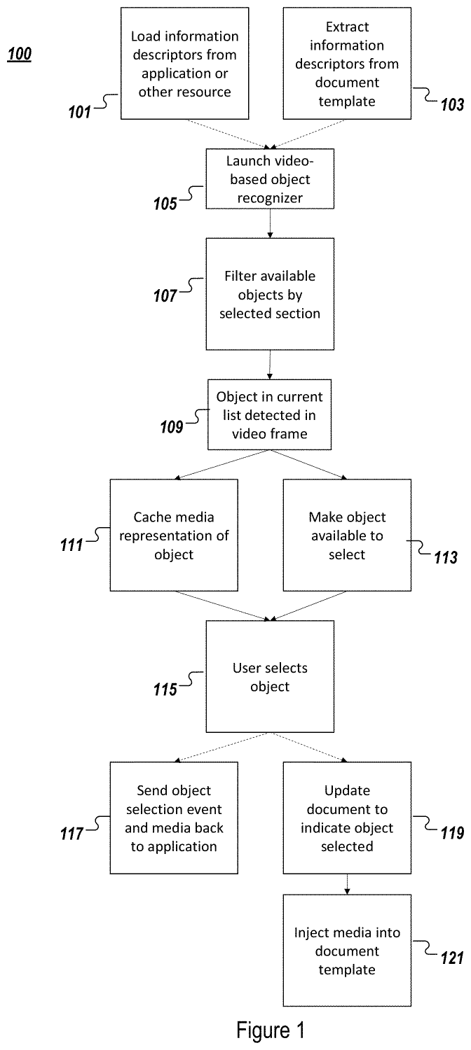

FIG. 1 illustrates an example implementation 100 associated with a dataflow diagram. Description of the example implementation 100 is provided with respect to phases of the example implementations: (1) information request acquisition, (2) detection of objects with live video, and (3) generating a response to the information request. While the foregoing phases are described herein, other actions may be taken before, between or after the phases. Further, the phases need not be performed in immediate sequence, but may instead be performed with time pauses between the sequences.

In the information request acquisition phase, a request is provided to the system for processing. For example, an external system may send an information request to an online mobile application, such as information descriptors from an application or other resource, as shown at 101. According to one example implementation, a payload may be obtained that includes text descriptions associated with the required information. For example, the payload (e.g., JSON) may optionally include extra information, such as whether the requested item has been currently selected, a type of the item (e.g., radio box item, media such as photo or the like), and a description of a group or section to which an item may belong.

Additionally, as shown at 103, one or more document templates may be provided to generate the information request. The present example implementations may perform parsing, by a document analysis tool, to extract one or more items in a document, such as a radio box. Optionally, the document analysis tool may perform extraction of more complex requests based on the document templates, such as media including photos, descriptive text or the like.

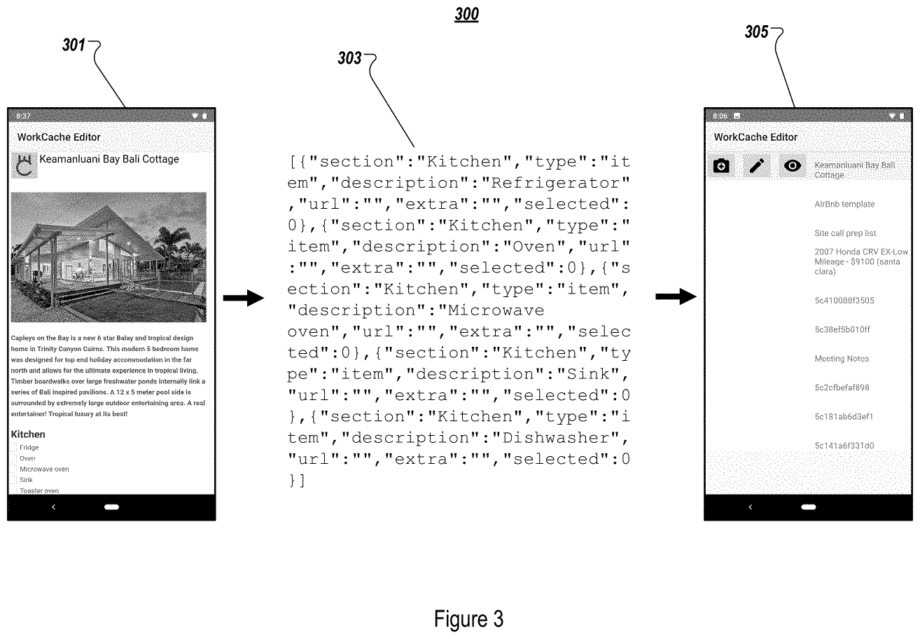

Once an information request has been acquired, as explained above with respect to 101 and 103, the online mobile application populates a user interface based on the information requests. For example, the user interface may be video-based. A user may choose from a list to generate a payload as explained above with respect to 103. The information obtained at 103 may be provided to a live viewer (e.g., video camera). Further explanation associated with the example approach in 103 is illustrated in FIG. 3 and described further below.

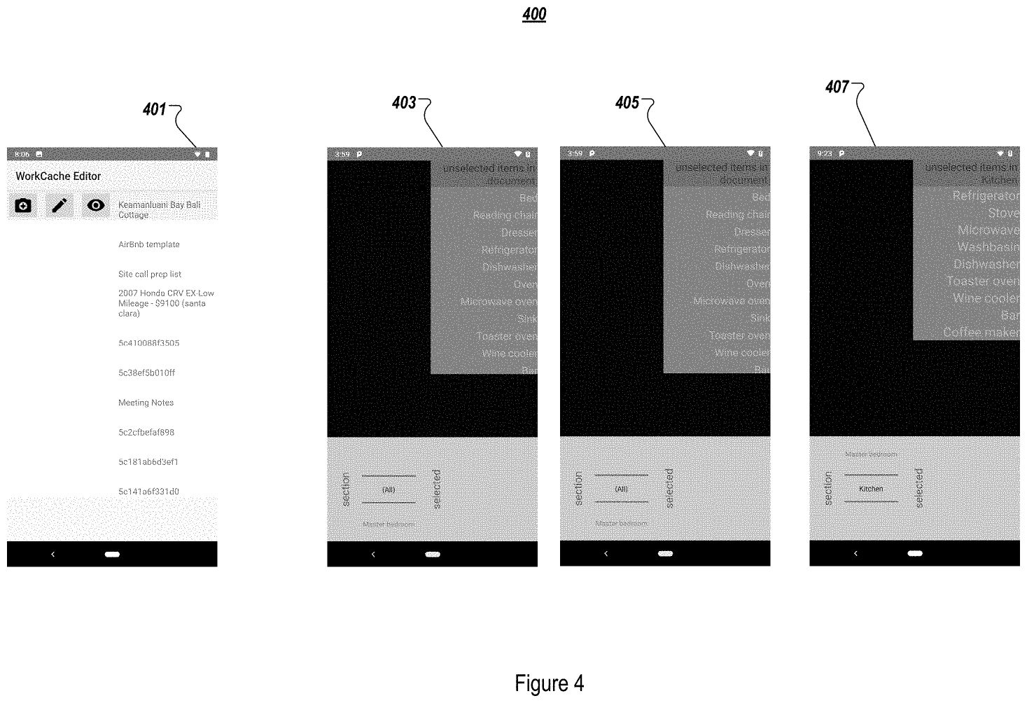

At 105, a video based object recognizer is launched. According to various aspects of the example implementations, one or more of the items may appear overlaid on a live video display, as explained in further detail below with respect to FIG. 4 (e.g., possible items appearing in upper right, overlaid on the live video displayed in the viewer). If the payload includes tokens having different sections, such as radio boxes associated with different sections of a document template, the user is provided with a display that includes a selectable list of sections, shown on the lower left in FIG. 4.

At 107, a filtering operation is performed. More specifically, objects with low confidence are filtered out. At 109, an object in the current list is detected in the video frame, as filtering is performed against the items from the information request. For example, with respect to FIG. 4, for a particular section being selected, a filter is applied against the current list of items. According to the example implementations, the user may select items with similar names in different sections of the document, as explained further below.

As the viewer operated by the user is employed to scan a viewer in the environment, an object recognizer is employed, such that the live viewer runs a separate thread analyzing frames. According to one example implementation, a TensorFlow Lite light framework is used with an image recognition model (e.g., Inception-v3) that is been trained on ImageNet, which may include approximately 10000 classes of items. As explained above, a configurable threshold filter eliminates objects for which the system has a low confidence.

The objects that pass through the configurable threshold filter are subsequently filtered against the items associated with the information request. In order for objects to pass this filter, each item is tokenized and stemmed, followed by the recognizing of the object description. Then, at least one token of each item is required to match at least one token from the object recognized. For example, but not by way of limitation, “Coffee Filter” would match “Coffee”, “Coffee Pot”, etc.

If the object passes the second filter, the frame of the object is cached at 111. At 113, the object is made available to the user to select, such as by highlighting the item in a user interface. Optionally, the caching may include optionally media such as a high resolution photo or other type of media of the object.

Further, it is noted that the object recognizer may be dynamically adapted. For example, the recognition confidence of object classes that are expected in the scene based on the information request may be boosted.

After an object has been detected with live video, a response to the information request is generated. For example, at 115, a user may select a highlighted item, by clicking or otherwise gesturing to select the item.

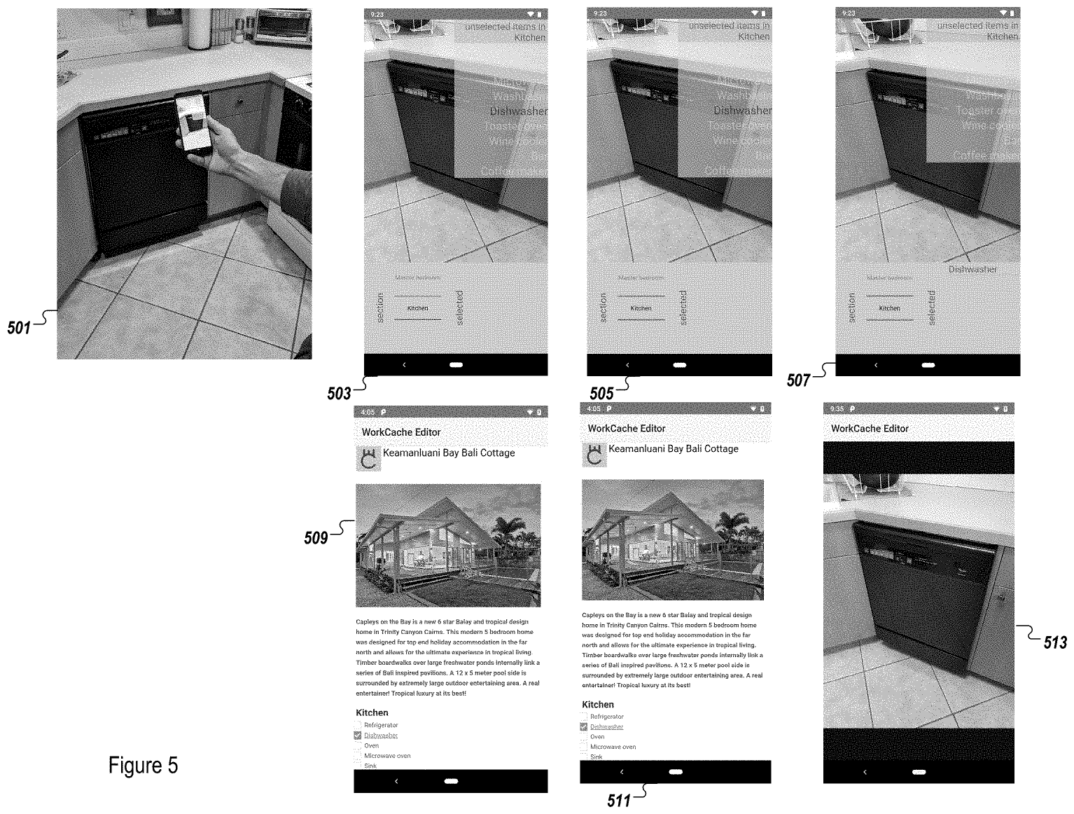

Once the item has been selected at 115, the item is removed from a list of possible items, to a list of selected items. For example, as shown in the sequence of FIG. 5, the term “Dishwasher” is selected, and is thus removed from the upper item list of potential items, and moved to the selected list provided below the upper item list.

At 117, an object selection event and media is provided back to the application. Further, on a background thread, the application forwards the selected item description and metadata, as well as the cached media (e.g., photo), to the requesting service. For example, the selection may be provided to a backend service.

At 119, an update of the corresponding document template is performed on the fly. More specifically, the backend service may select items corresponding to the radio box. At 121, media is injected into the corresponding document template, such as injection of a link to an uploaded media such as a photo.

Optionally, a user may deselect an item at any point by interaction with the online mobile application. The deselecting action will generate a deselection event, which is provided to the listening service.

Additionally, the online mobile application may include a document editor and viewer. Accordingly, users may confirm updates that are provided by the object recognition component.

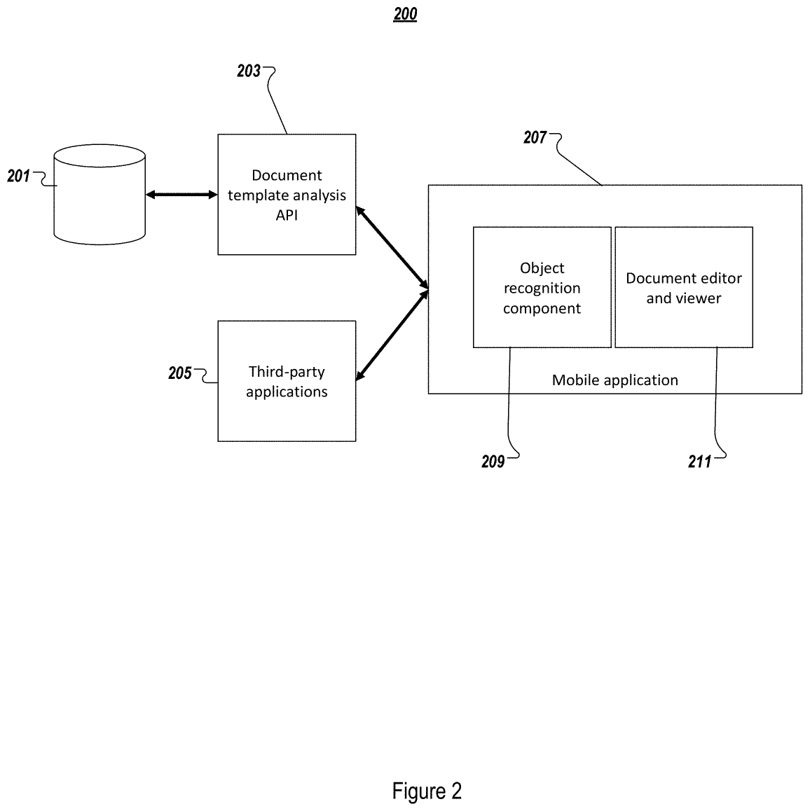

FIG. 2 illustrates a system architecture 200 associated with the example implementations. A database or information base 201 of document templates may be provided, for which a document template analysis application programming interface (API) may be provided at 203 to acquire the information request.

Further, one or more third-party applications 205 may also be used to acquire the information request. In some example implementations, information requests may be received from one or more sources that are not associated with to a template. For example, but not by way of limitation, in a medical scenario, a health care professional such as a doctor might request a patient to collect media of the arrangement of a medical device remotely from the health care professional (e.g., at home or in a telemedicine kiosk). The data collected from this request may be provided or injected in a summary document for the health care professional, or injected into a database field on a remote server, and provided (e.g., displayed) to the doctor via one or more interface components (e.g., mobile messaging, tab in an electronic health record, etc.).

According to further example implementations, some collected information may not be provided in an end-user interface component, but may instead be provided or injected into an algorithm (e.g., a request for photos of damage for insurance purposes may be fed directly into an algorithm to assess coverage). Further, the requests for information may also be generated from a source other than a template, such as a manual or automated request from a third-party application.

An online mobile application 207 is provided for the user, via the viewer, such as a video camera on the mobile device, to perform object detection and respond to the information request. For example, this is described above with respect to 105-113 and 115-121, respectively. An object recognition component 209 may be provided, to perform detection of objects with live video as described above with respect to 105-113. Further, a document editor and viewer 211 may be provided, to respond to the information request as described above with respect to 115-121.

While the foregoing system architecture 200 is described with respect to example implementations of the data flow 100, the present example implementation is not limited thereto, and further modifications may be employed without departing from the inventive scope. For example, but not by way of limitation, a sequence of operations that are performed in parallel may instead be performed in series, or vice versa. Further, an application that is performed at a client of an online mobile application may also be performed remotely, or vice versa.

Additionally, the example implementations include aspects directed to handling of misrecognition of an object. For example, but not by way of limitation, if a user directs the viewer, such as a video camera on a mobile phone, but the object itself is not recognized by the object recognizer, an interactive support may be provided to the user. For example, but not by way of limitation, the interactive support may provide the user with an option to still capture the information, or may direct the user to provide additional visual evidence associated with the object. Optionally, the newly captured data may be used by the object recognizer model to perform improvement of the model.

For example, but not by way of limitation, if an object has changed in appearance, the object recognizer may not be able to successfully recognize the object. On the other hand, there is a need for the user to be able to select the object from the list, and provide visual evidence. One example situation would be in the case of an automobile body, wherein an object originally had a smooth shape, such as a fender, and was later involved in a collision or the like, and the fender is damaged or disfigured, such that it cannot be recognized by the object recognizer.

If a user positions the viewer at the desired object, such as the fender of the automobile and the object recognizer does not correctly recognize the object, or even recognize the object at all, the user may be provided with an option to manually intervene. More specifically the user may select the name of the item in the list, such that a frame, high resolution image or frame sequence is captured. The user may then be prompted to confirm whether an object of the selected type is visible. Optionally, the user may suggest, or require the user to provide, additional evidence from additional aspects or angles of view.

Further, the provided frames and object name may be used as new training data, to improve the object recognition model. Optionally, a verification may be performed for the user to confirm that the new data is associated with the object, such a verification may be performed prior to modifying the model. In one example situation, the object may be recognizable in some frames, but not in all frames.

According to additional example implementations, further image recognition models may be generated for targeted domains. For example, but not by way of limitation, image recognition models may be generated for domains such as retraining or transfer learning. Further, according to still other example implementations, objects may be added which do not specifically appear in the linked document template. For example but not by way of limitation, the object recognizer might generate an output that includes detected objects that match a higher-level section or category from the document.

Further, while the foregoing example implementations may employ information descriptors that are loaded or extracted, other aspects may be directed to using the foregoing techniques to build a list of requested information. For example, but not by way of limitation, a tutorial video may be provided with instructions, where the list of necessary tools is collected using video and object detection on-the-fly.

According to some additional example implementations, in addition to allowing the user to use the hierarchy of the template, other options may be provided. For example, the user may be provided with a setting or option to modify the existing hierarchy, or to make an entirely new hierarchy, to conduct the document analysis.

FIG. 3 illustrates aspects 300 associated with a user experience according to the present example implementations. These example implementations include, but are not limited to, displays are provided to an online mobile application in the implementation of the above described aspects with respect to FIGS. 1 and 2.

Specifically, at 301, an output of a current state of a document is displayed. This document is generated from a list of documents provided to a user at 305. The information associated with these requests may be obtained via the online application, or a chat bot guiding a user through a wizard or other series of step-by-step instructions to complete a listing, insurance claim or other request.

The aspects shown at 301 illustrate a template, in this case directed to a rental listing. The template may include items that might exist in a listing such as a rental and need to be documented. For example, as shown in 301, an image of a property is shown with a photo image, followed by a listing of various rooms of the rental property. For example, with respect to the kitchen, items of the kitchen are individually listed.

As explained above with respect to 101-103 of FIG. 1, the document template may provide various items, and a payload may be extracted, as shown in 303. In 305, a plurality of documents is shown, the first of which is the output shown in 301.

FIG. 4 illustrates additional aspects 400 associated with a user experience according to the present example implementations. For example, but not by way of limitation, at 401, a list of documents in the application of the user is shown. The user may select one of the applications, in this case the first listed application, to generate an output of all of the items that are available to be catalogued in the document, as shown in 403, including all of the items listed in the document that have not been selected. As shown in the lower left portion of 403, a plurality of sections are shown for selection.

For the situation in which a section is selected at 407 from the scrolling list at the bottom of the interface, such as “Kitchen”, an output 407 is provided to the user. More specifically, a listing of unselected items that are present in the selected section is provided, in this case the items present in the kitchen.

FIG. 5 illustrates additional aspects 500 associated with a user experience according to the present example implementations. For example, but not by way of limitation, at 501, the user has focused the viewer, or video camera, to a portion of the kitchen in which he or she is located. The object recognizer, using the operations explained above, detects an item. The object recognizer provides a highlighting of the detected item to the user, in this case “Dishwasher”, as shown in highlighted text in 503.

Once the user has selected the highlighted item, by clicking, gesture, etc., as shown in 505, an output as shown in 507 is displayed. More specifically, the dishwasher in the live video associated with the viewer is labeled, and the term “Dishwasher” in the kitchen that is shown in the top right of 507.

Accordingly, by selecting the item as shown in 505, the associated document is updated. More specifically, as shown in 509, the term “Dishwasher” as shown in the list is linked with further information, including media such as a photo or the like.

Further, as shown in 511, when the linked term is selected by the user, an image of the item associated with the linked term is displayed, in this case the dishwasher, as shown in 513. In this example implementation, the live video is used to provide live object recognition, with the semi-automatic cataloging of the items.

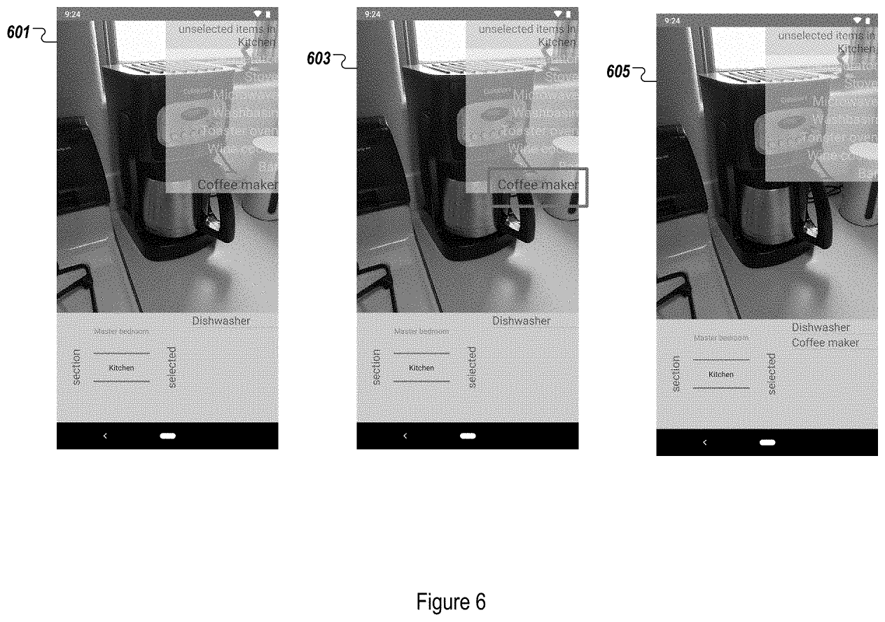

FIG. 6 illustrates additional aspects 600 associated with a user experience according to the present example implementations. In this example implementation, the selection as discussed above has been made, and the item of the dishwasher has been added to the kitchen items.

At 601, the user moves the focus of the image capture device, such as the video camera of the mobile phone, in a direction of a coffeemaker. The object recognizer provides an indication that the object in the focus of the image is characterized or recognized as a coffeemaker.

At 603, the user, by clicking or gesturing, or other manner of interacting with the online application, selects the coffeemaker. At 605, the coffeemaker is added to a list of items at the bottom right of the interface for the kitchen section, and is removed from the list of unselected items in the upper right corner.

Accordingly, as shown in the forgoing disclosures, in addition to a first item that has already been selected, in moving the focus of the viewer, the user may use the object recognizer to identify and select another object.

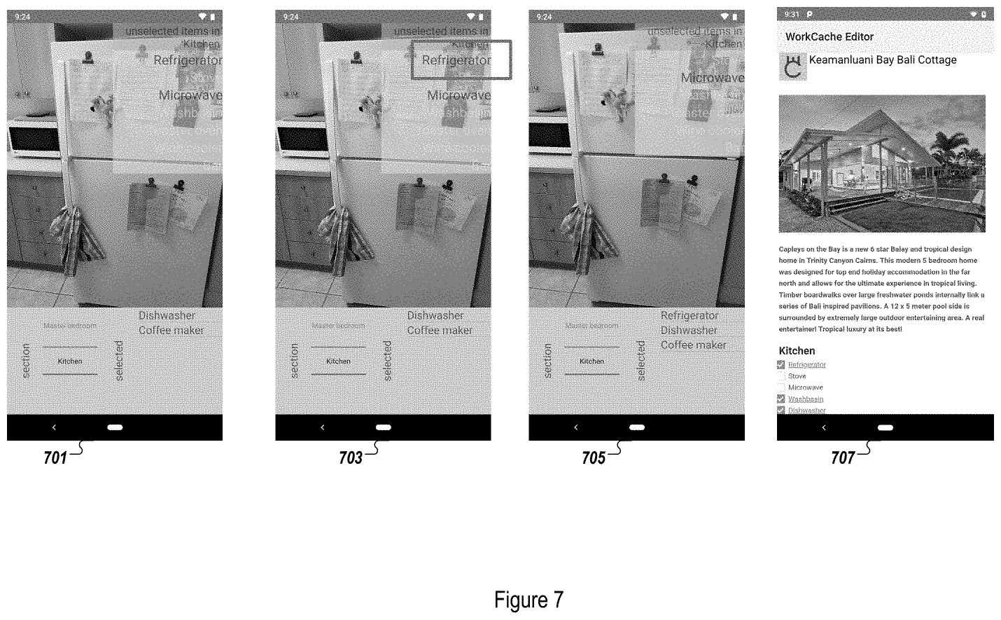

FIG. 7 illustrates additional aspects 700 associated with a user experience according to the present example implementations. In this example implementation, the selection as discussed above has been made, and the item of the coffeemaker has been added to the list of selected kitchen items.

At 701, the user moves the focus of the viewer in the direction of a refrigerator in the kitchen. However, there is also a microwave oven next to the refrigerator. The object recognizer provides an indication that there are two unselected items in the live video, namely a refrigerator and a microwave, as highlighted in the unselected items list at 701.

At 703, the user selects, by click, user gesture or other interaction with the online application, the refrigerator. Thus, at 705, the refrigerator is removed from the list of unselected items, and is added to the list of selected items for the kitchen section. Further, at 707, the associated document is updated to show a link to the refrigerator, dishwasher and washbasin.

According to the example implementations, the object recognizer may provide user with a choice of multiple objects that are in a live video, such that the user may select one or more of the objects.

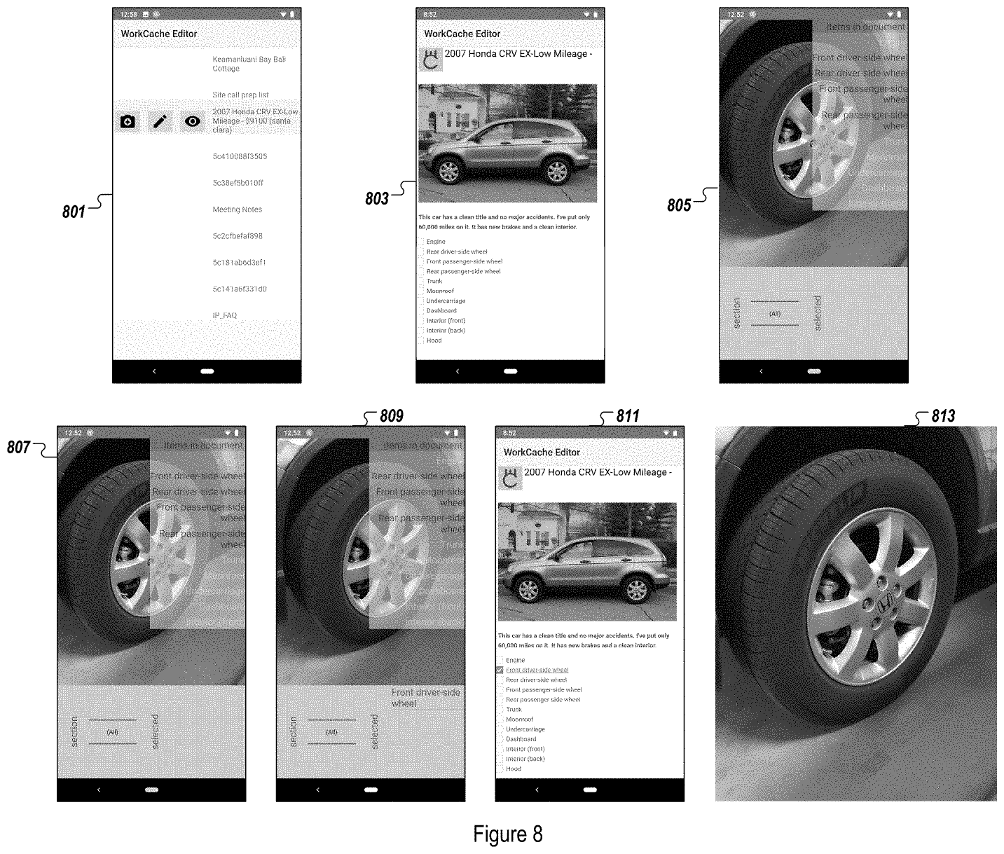

FIG. 8 illustrates additional aspects 800 associated with a user experience according to the present example implementations. As shown at 801, a user may select one of the documents from the list of documents.. In this example implementation, the user selects an automobile that he or she is offering for sale. The document is shown at 803, including a media (e.g., photograph), description and list of items that may be associated with the object.

At 805, an interface associated with the object recognizer is shown. More specifically, the live video is focused on a portion of the vehicle, namely a wheel. The object recognizer provides an indication that, from the items in the document, the item in the live video may be front or rear side wheel, on either the passenger or driver side.

At 807, the user selects the front driver side wheel from the user interface, such as by clicking gesturing, or other interaction with the online mobile application. Thus, at 809, the front driver side wheel is deleted from the list of unselected items in the document, and added to the list of selected items in the bottom right corner. At 811, the document is updated to show the front driver side wheel as being linked, and upon selecting on the link, at 813, an image of the front driver side wheel is shown, such as to the potential buyer.

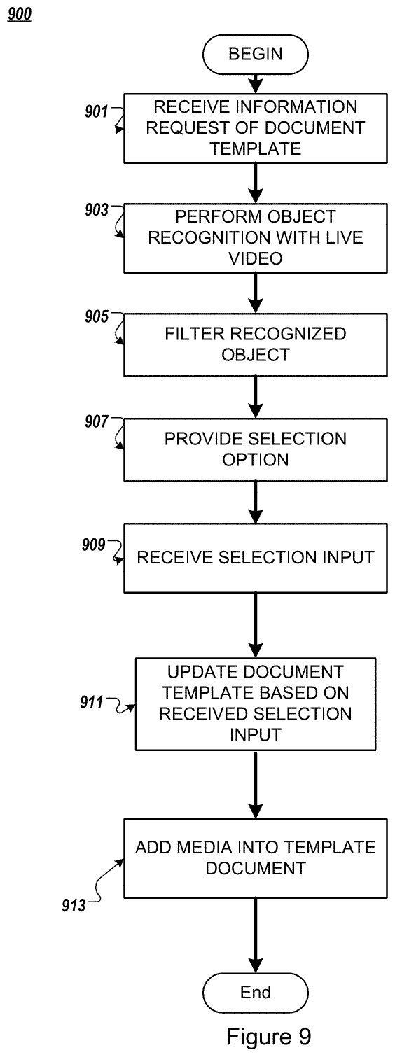

FIG. 9 illustrates an example process 900 according to the example implementations. The example process 900 may be performed on one or more devices, as explained herein.

At 901, an information request is received (e.g., at an online mobile application). More specifically, the information request may be received from a third party external source, or via a document template. If the information request is received via a document template, the document may be parsed to extract items (e.g., radio boxes). This information may be received via a document template analysis API as a payload, for example.

At 903, live video object recognition is performed. For example, the payload may be provided to a live viewer, and the user may be provided with an opportunity to select an item from a list of items. One or more hierarchies may be provided, so that the user can select items for one or more sections. Additionally, the live viewer runs a separate thread that analyzes frames with an object recognizer.

At 905, as objects are recognized, each object is filtered. More specifically, an object is filtered against a confidence threshold indicative of a likelihood that the object in the live video matches the result of the object recognizer.

At 907, for the objects that remain after the application of the filter, the user is provided with a selection option. For example, the remaining objects after filtering may be provided to the user in a list on the user interface.

At 909, the user interface of the online mobile application receives an input indicative of a selection of an item. For example, the user may click, gesture, or otherwise interface with the online mobile application to select an item from the list.

At 911, a document template is updated based on the received user input. For example, the item may be removed from a list of unselected items, and added to a list of selected items. Further, and on a separate thread, at 913, the application provides the selected item description and metadata, as well as the cached photo, for example, to a requesting service.

In the foregoing example implementation, the operations are performed at an online mobile application associated with a user. For example, a client device may include a viewer that receives the live video. However, the example implementations are not limited thereto, and other approaches may be substituted therefor without departing from the inventive scope. For example, but not by way of limitation, other example approaches may perform the operations remotely from the client device (e.g., at a server). Still other example implementations may use viewers that are remote from the users (e.g., sensors or security video cameras proximal to the objects, and capable of being operated without the physical presence of the user).

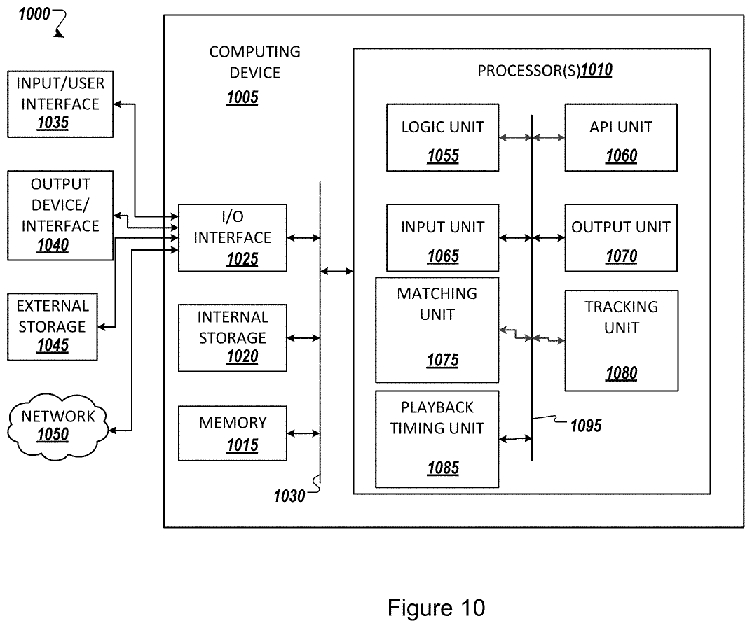

FIG. 10 illustrates an example computing environment 1000 with an example computer device 1005 suitable for use in some example implementations. Computing device 1005 in computing environment 1000 can include one or more processing units, cores, or processors 1010, memory 1015 (e.g., RAM, ROM, and/or the like), internal storage 1020 (e.g., magnetic, optical, solid state storage, and/or organic), and/or I/O interface 1025, any of which can be coupled on a communication mechanism or bus 1030 for communicating information or embedded in the computing device 1005.

Computing device 1005 can be communicatively coupled to input/interface 1035 and output device/interface 1040. Either one or both of input/interface 1035 and output device/interface 1040 can be a wired or wireless interface and can be detachable. Input/interface 1035 may include any device, component, sensor, or interface, physical or virtual, which can be used to provide input (e.g., buttons, touch-screen interface, keyboard, a pointing/cursor control, microphone, camera, braille, motion sensor, optical reader, and/or the like).

Output device/interface 1040 may include a display, television, monitor, printer, speaker, braille, or the like. In some example implementations, input/interface 1035 (e.g., user interface) and output device/interface 1040 can be embedded with, or physically coupled to, the computing device 1005. In other example implementations, other computing devices may function as, or provide the functions of, an input/ interface 1035 and output device/interface 1040 for a computing device 1005.

Examples of computing device 1005 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, server devices, other computers, information kiosks, televisions with one or more processors embedded therein and/or coupled thereto, radios, and the like).

Computing device 1005 can be communicatively coupled (e.g., via I/O interface 1025) to external storage 1045 and network 1050 for communicating with any number of networked components, devices, and systems, including one or more computing devices of the same or different configuration. Computing device 1005 or any connected computing device can be functioning as, providing services of, or referred to as, a server, client, thin server, general machine, special-purpose machine, or another label. For example but not by way of limitation, network 1050 may include the blockchain network, and/or the cloud.

I/O interface 1025 can include, but is not limited to, wired and/or wireless interfaces using any communication or I/O protocols or standards (e.g., Ethernet, 802.11xs, Universal System Bus, WiMAX, modem, a cellular network protocol, and the like) for communicating information to and/or from at least all the connected components, devices, and network in computing environment 1000. Network 1050 can be any network or combination of networks (e.g., the Internet, local area network, wide area network, a telephonic network, a cellular network, satellite network, and the like).

Computing device 1005 can use and/or communicate using computer-usable or computer-readable media, including transitory media and non-transitory media. Transitory media includes transmission media (e.g., metal cables, fiber optics), signals, carrier waves, and the like. Non-transitory media includes magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computing device 1005 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1010 can execute under any operating system (OS) (not shown), in a native or virtual environment. One or more applications can be deployed that include logic unit 1055, application programming interface (API) unit 1060, input unit 1065, output unit 1070, information request acquisition unit 1075, object detection unit 1080, information request response unit 1085, and inter-unit communication mechanism 1095 for the different units to communicate with each other, with the OS, and with other applications (not shown).

For example, the information request acquisition unit 1075, the object detection unit 1080, and the information request response unit 1085 may implement one or more processes shown above with respect to the structures described above. The described units and elements can be varied in design, function, configuration, or implementation and are not limited to the descriptions provided.

In some example implementations, when information or an execution instruction is received by API unit 1060, it may be communicated to one or more other units (e.g., logic unit 1055, input unit 1065, information request acquisition unit 1075, object detection unit 1080, and information request response unit 1085).

For example, the information request acquisition unit 1075 may receive and process information, from a third party resource and/or a document template, including extraction of information descriptors from the document template. An output of the information request acquisition unit 1075may provide a payload, which is provided to the object detection unit 1080, which detects an object with live video, by applying the object recognizer to output an identity of an item in the live video, with respect to information included in the document. Additionally, the information request response unit 1085 may provide information in response to a request, based on the information obtained from the information request acquisition unit 1075 and the object detection unit 1080.

In some instances, the logic unit 1055 may be configured to control the information flow among the units and direct the services provided by API unit 1060, input unit 1065, information request acquisition unit 1075, object detection unit 1080, and information request response unit 1085 in some example implementations described above. For example, the flow of one or more processes or implementations may be controlled by logic unit 1055 alone or in conjunction with API unit 860.

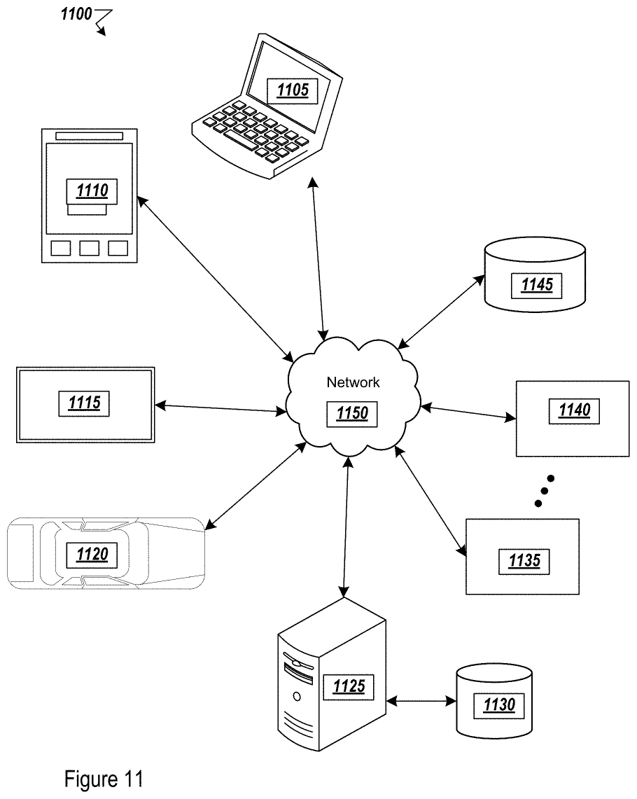

FIG. 11 shows an example environment suitable for some example implementations. Environment 1100 includes devices 1105-1145, and each is communicatively connected to at least one other device via, for example, network 1160 (e.g., by wired and/or wireless connections). Some devices may be communicatively connected to one or more storage devices 1130 and 1145.

An example of one or more devices 1105-1145 may be computing devices 1005 described in FIG. 10, respectively. Devices 1105-1145 may include, but are not limited to, a computer 1105 (e.g., a laptop computing device) having a monitor and an associated webcam as explained above, a mobile device 1110 (e.g., smartphone or tablet), a television 1115, a device associated with a vehicle 1120, a server computer 1125, computing devices 1135-1140, storage devices 1130 and 1145.

In some implementations, devices 1105-1120 may be considered user devices associated with the users, who may be remotely obtaining a live video to be used for object detection and recognition, and providing the user with settings and an interface to edit and view the document. Devices 1125-1145 may be devices associated with service providers (e.g., used to store and process information associated with the document template, third party applications, or the like). In the present example implementations, one or more of these user devices may be associated with a viewer comprising one or more video cameras, that can sense a live video, such as a video camera sensing the real time motions of the user and provide the real time live video feed to the system for the object detection and recognition, and the information request processing, as explained above.

Aspects of the example implementations may have various advantages and benefits. For example, but not by way of limitation, in contrast to the related art, the present example implementations integrate live object recognition and semi-automatic cataloging of items. Therefore, the example implementations may provide a stronger likelihood that an object was captured, as compared with other related art approaches.

For example, with respect to real estate listings, the buyer or seller, or the realtor, using the foregoing example implementations, may be able to provide documentation from the live video feed that is associated with various features of the real estate, and allow the user (e.g., buyer, seller or realtor) to semi-automatically catalog requested items and collect evidence associated with their current physical state. For example, the documentation from the live video feed may include information on the condition of the lot, appliances located in the building on the real estate, condition of fixtures and other materials, etc.

Similarly, for short-term rentals (e.g., house, automobile, etc.), the lessor, using the foregoing example implementations, may be able to collect evidence associated with items on the property, such as evidence of the presence as well as the condition of items, before and after a rental, using a live video feed. Such information may be useful to more accurately assess whether maintenance needs to be performed, items need to be replaced, or for insurance claims or the like. Further, the ability to semi-automatically catalog items may permit the insurer and the insured to more precisely identify and assess a condition of items.

Further, in the instance of an insurance claim, using the foregoing example implementations, insurance organizations may be able to obtain, from a claimant, evidence based on a live video. For example, in the instance of automobile damage, such as due to a collision or the like, a claimant may be able provide media such as photographs or other evidence that is filed with the insurance claim, and is based on the live video feed; the user as well as the insurer may semi-automatically catalog items, to more precisely define the claim.

In another use of the foregoing example implementations, sellers of non-real estate property, such as objects sold online, may be able to use the online application to apply a live video to document various aspects of the item, for publication in online sales websites or applications. For example, and as shown above, a seller of an automobile use live video to document a condition of various parts of the automobile, so that a prospective buyer can see media such as photographs of body, engine, tires, interior, etc., based on a semi-automatically cataloged list of items.

In yet another application of the example implementations, an entity providing a service may document a condition of an object upon which services to be performed, both before and after the providing of the service, using the live video. For example, an inspector or a field technician servicing a printer such as an MFP may need to document one or more specific issues before filing a work order, or verify that the work order has been successfully completed, and may implement the semi-automatic cataloging feature to more efficiently complete the services.

In a medical field example implementation, surgical equipment may be confirmed and inventoried using the real time video, thereby ensuring that all surgical instruments have been successfully collected and accounted for after a surgical operation has been performed, to avoid SAEs, such as RSI SAE's. Given the number and complexity of surgical tools, the semi-automatic catalog feature may permit the medical professionals to more precisely and efficiently avoid such events.

In another example implementation in the medical field, a medical professional may be able to confirm proper documentation of patient issues, such as documentation of a wound, skin disorder, limb flexibility condition, or other medical condition, using a live video indicative of current condition, and thus more precisely effect a treatment, especially when considering patients who are met remotely, such as by way of a telemedicine interface or the like. Semi-automatic cataloging can be implemented to permit medical professionals and patients to focus on the specific patient issues, and do so with respect to the real-time condition of the patient.

Although a few example implementations have been shown and described, these example implementations are provided to convey the subject matter described herein to people who are familiar with this field. It should be understood that the subject matter described herein may be implemented in various forms without being limited to the described example implementations. The subject matter described herein can be practiced without those specifically defined or described matters or with other or different elements or matters not described. It will be appreciated by those familiar with this field that changes may be made in these example implementations without departing from the subject matter described herein as defined in the appended claims and their equivalents.

What is claimed is:

1. A computer-implemented method, comprising:
receiving a request from a third party source or on a template to generate a payload;
receiving a live video via a viewer, and performing recognition on an object in the live video to determine whether the object is an item in the payload;
filtering the object against a threshold indicative of a likelihood of the object matching a determination of the recognition;
receiving an input indicative of a selection of the item; and
updating the template based on the received input, and providing information associated with the object to complete the request.

2. The computer-implemented method of claim 1, wherein for the request received from the third party external source, the third party external source comprises one or more of a database, a document, and a manual or automated request associated with an application.

3. The computer-implemented method of claim 1, further comprising, for the request being received via the template, parsing the document to extract the item.

4. The computer-implemented method of claim 3, further comprising providing a template analysis application programming interface (API) to generate the payload.

5. The computer-implemented method of claim 1, wherein the user can select items for one or more sections in a hierarchical arrangement.

6. The computer-implemented method of claim 1, wherein the viewer runs a separate thread that analyzes frames of the viewer with the recognizer.

7. The computer-implemented method of claim 1, further comprising filtering the object against items received in the payload associated with the request.

8. The computer-implemented method of claim 7, wherein each of the items is tokenized and stemmed with respect to the object on which the recognition has been performed.

9. The computer-implemented method of claim 1, wherein the recognizing is dynamically adapted to boost the threshold for the object determined to be in the viewer based on the request.

10. The computer-implemented method of claim 1, wherein the information comprises at least one of a description, metadata, and media.

11. A non-transitory computer readable medium having a storage that stores instructions, the instructions executed by a processor, the instructions comprising:
receiving a request from a third party source or on a template to generate a payload;
receiving live video via a viewer, and performing recognition on an object in the live video to determine whether the object is an item in the payload;
filtering the object against a threshold indicative of a likelihood of the object matching a determination of the recognition;
receiving an input indicative of a selection of the item; and
updating the template based on the received input, and providing information associated with the object to complete the request.

12. The non-transitory computer readable medium of claim 11, wherein the user can select items for one or more sections.

13. The non-transitory computer readable medium of claim 11, wherein the viewer runs a separate thread that analyzes frames of the viewer with the recognizer.

14. The non-transitory computer readable medium of claim 11, further comprising filtering the object against items received in the payload associated with the request, wherein each of the items is tokenized and stemmed with respect the object on which the recognition has been performed.

15. The non-transitory computer readable medium of claim 11, wherein the recognizing is dynamically adapted to boost the threshold for the object determined to be in the viewer based on the request.

16. The non-transitory computer readable medium of claim 11, wherein the information comprises at least one of a description, metadata, and media.

17. A processor capable of processing a request, the processor configured to perform the operations of:
receiving the request on a template to generate a payload;
receiving live video via a viewer, and performing recognition on an object in the live video to determine whether the object is an item in the payload;
filtering the object against a threshold indicative of a likelihood of the object matching a determination of the recognition;
receiving an input indicative of a selection of the item by the user; and
updating the template based on the received input, and providing information associated with the object to complete the request.

18. The processor of claim 17, further comprising a viewer that runs a separate thread that analyzes frames of the viewer with the recognizer.

19. The processor of claim 17, wherein the performing recognition further comprises the object against items received in the payload associated with the request, wherein each of the items is tokenized and stemmed with respect the object on which the recognition has been performed.

20. The processor of claim 17, wherein the performing recognition is dynamically adapted to boost the threshold for the object determined to be in the viewer based on the request.
